(19) United States
(12) Patent Application Publication
(10) Pub. No.: US 2024/0352847 A1
(43) Pub. Date: Oct. 24, 2024

(54) EXPLORATION DYNAMIC DATA ANALYSIS AND DISPLAY TOOL

(71) Applicant: SAUDI ARABIAN OIL COMPANY, Dhahran (SA)

(72) Inventors: Zerai Tecle Andegeorgs, Dhahran (SA); Fahad Najrani, Dhahran (SA)

(73) Assignee: SAUDI ARABIAN OIL COMPANY, Dhahran (SA)

(21) Appl. No.: 18/303,266

(22) Filed: Apr. 19, 2023

(51) Int. Cl. E21B 47/002; E21B 7/04; G01V 1/34

(52) U.S. Cl. CPC E21B 47/0025; E21B 7/04; G01V 1/345

(57) ABSTRACT

A method and system for identifying a drilling target within a subsurface region of interest based on a visual representation is provided. The method may include projecting a plurality of wellbores penetrating the subsurface region of interest onto a line of section and for each of the plurality of wellbores, determining a stratigraphic column and a petroleum system description. A regional stratigraphic column may be determined based on the stratigraphic column from each wellbore and a visual representation may be generated that includes the regional stratigraphic column aligned with the petroleum system description from each of the plurality of wellbores. The method may further include displaying the visual representation on a display device and identifying a drilling target within the subsurface region of interest based on the visual representation using an interpretation workstation.

### BACKGROUND

In the petroleum industry, hydrocarbons are located in reservoirs far beneath the surface of the Earth. Wells are drilled into these reservoirs to access and produce hydrocarbons. There are numerous types of hydrocarbon exploration methods, many of which incorporate the full extent of available geological information of a particular region, in order to determine a drilling target, or a chosen location to penetrate a hydrocarbon reservoir. Play-based exploration (PBE) is one type of hydrocarbon exploration method. PBE is a multi-disciplinary exploration workflow that is founded on an understanding of a basin's regional geology, petroleum systems, plays and exploration activity. A basin or sedimentary basin is a depression in the Earth's crust, that has accumulated sediments over time and a great majority of oil reservoirs are found exploring these basins.

The initial focus of PBE is referred to as the basin focus, and the goal is to develop a strong understanding of the regional geology and petroleum systems of an area of interest. This understanding is further expanded by identifying and mapping plays within the basin, known as the play focus. A hydrocarbon play refers to a broad region that contains the right petroleum system elements for a hydrocarbon accumulation to be present. Existing knowledge from production or exploration wells in the region are summarized in the play focus stage to help narrow down a drilling target. Finally, the PBE method includes a prospect focus. In the prospect focus stage, additional exploration techniques may be performed on potential plays, to identify a hydrocarbon prospect. A hydrocarbon prospect refers to a subsurface location where there is a high confidence of an economical hydrocarbon deposit. Improvements in PBE techniques at any one of the three focus stages may aid in determining an advantageous drilling target in less time and reduce the uncertainty.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relating to a method for identifying a drilling target within a subsurface region of interest based on a visual representation are described. The method may include projecting a plurality of wellbores penetrating the subsurface region of interest onto a line of section and for each of the plurality of wellbores, determining a stratigraphic column and a petroleum system description. A regional stratigraphic column may be determined based on the stratigraphic column from each wellbore and a visual representation may be generated that includes the regional stratigraphic column aligned with the petroleum system description from each of the plurality of wellbores. The method may further include displaying the visual representation on a display device and identifying a drilling target within the subsurface region of interest based on the visual representation using an interpretation workstation.

In general, in one aspect, embodiments relate to a system configured to generate a visual representation from a spatial map containing a plurality of wellbores. The system may include a computer processor configured to project the plurality of wellbores that penetrate a subsurface region of interest onto a line of section, where each of the plurality of wellbores include a well log and a well test result and determine a stratigraphic column for each of the plurality of wellbores based on the well log. The computer processor of the system may be further configured to determine a petroleum system description for each of the plurality of wellbores based on the well log and the well test result, determine a regional stratigraphic column based on the stratigraphic column from each of the plurality of wellbores, generate the visual representation that includes the regional stratigraphic column aligned with the petroleum system description from each of the plurality of wellbores and display the visual representation on a display device. The system may also include an interpretation workstation configured to identify a drilling target within the subsurface region of interest based on the visual representation.

Other aspects and advantages of the claimed subject matter will be apparent from the following description and the appended claims.

### BRIEF DESCRIPTION OF DRAWINGS

Specific embodiments disclosed herein will now be described in detail with reference to the accompanying figures. Like elements in the various figures are denoted by like reference numerals for consistency. Like elements may not be labeled in all figures for the sake of simplicity.

FIG. 1 depicts a system with one or more embodiments.

FIG. 2 depicts a series of well logs in accordance with one or more embodiments.

FIG. 3 depicts a stratigraphic column in accordance with one or more embodiments.

FIG. 4 depicts a spatial map in accordance with one or more embodiments.

FIG. 5 depicts a visual representation aiding in PBE in accordance with one or more embodiments.

FIG. 6 shows a flowchart in accordance with one or more embodiments.

FIG. 7 depicts an attribute map in accordance with one or more embodiments.

FIG. 8 depicts a drilling system in accordance with one or more embodiments.

FIG. 9 depicts a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

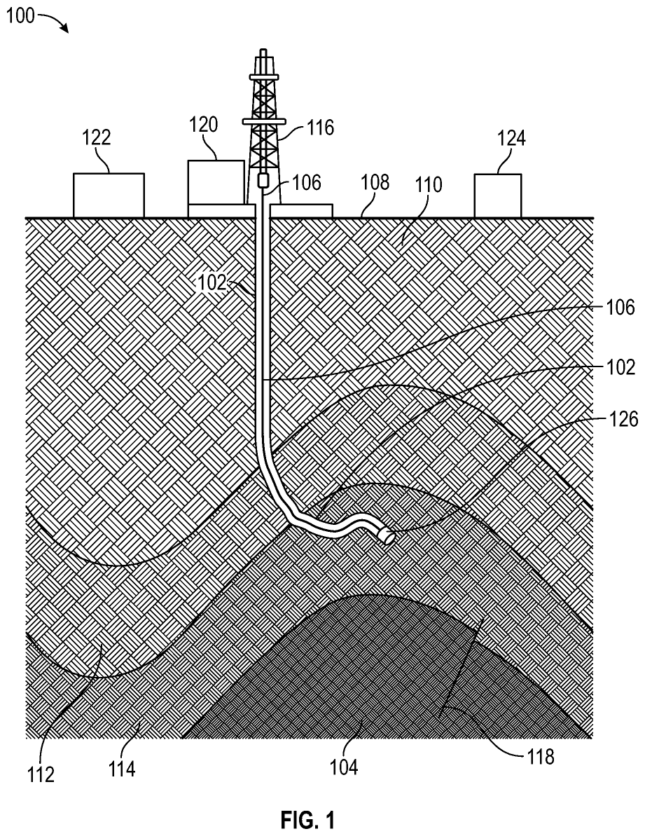

In the following description of FIGS. 1-9, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a passive soil gas sample system” includes reference to one or more of such systems.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

The embodiments disclosed herein include methods and systems for generating a visual representation using regional stratigraphic data combined with petroleum system descriptions from a plurality of wellbores in a region of interest. The petroleum system descriptions may describe hydrocarbon test and show data, which visualizes a verified presence of different subsurface hydrocarbon fluids. By offering a visual representation of these petroleum system elements, a strong understanding of a regions petroleum system may be developed to augment a PBE. The method includes projecting a plurality of wellbores penetrating a subsurface region of interest onto a line of section by interrogating a spatial map that includes the wellbores, forming the line of section on the spatial map and projecting spatial coordinates of a wellhead onto the line of section. For the wellbores selected onto the line of section, a stratigraphic column is determined based on the well log and a petroleum system description is then determined based on the well log and a well test result. A regional stratigraphic column is then determined based on the stratigraphic column from each of the wellbores and a visual representation is generated that includes this regional stratigraphic column aligned with the petroleum system descriptions. The visual representation is generated by partitioning the regional stratigraphic column aligned with each petroleum system description into a series of rows that categorizes a petroleum system formation and the petroleum system descriptions are labeled using a plurality of differentiators.

The visual representation may be displayed on a display device and a drilling target may be identified using an interpretation workstation based, at least in part, on the visual representation. The visual representation may be used to identify a drilling target pattern based on the plurality of differentiators, which help to visualize the interval petroleum system descriptions for the plurality of wellbores projected on the line of section. The visual representation enables an efficient visual analysis of both local and regional play risk elements and their relationships to one another, which may be used to quickly identify a drilling target. A wellbore path, or trajectory may then be planned, using a wellbore path planning system, to intersect the drilling target and a wellbore may be drilled guided by the wellbore path using a drilling system.

FIG. 1 depicts a petroleum system (100) in accordance with one or more embodiments. The petroleum system (100) includes a source rock formation (104), or rocks in which hydrocarbons have been generated or are capable of hydrocarbon generation. A source rock formation (104) is one of the necessary elements of a petroleum system (100) and includes organic-rich sediments that may be deposited in a variety of environments. When these organic-rich sediments are heated sufficiently, hydrocarbons may be created. With hydrocarbons present in a source rock formation (104) a petroleum system (100) requires a migration of these hydrocarbons into a reservoir formation (114). The hydrocarbons may migrate vertically through faults (118) or fractures upwards into a hydrocarbon reservoir (114). The fault (118) depicted in FIG. 1 fractures and displaces the source rock formation (104), allowing for the escape of the hydrocarbons in these cases. Hydrocarbon migration may also occur as a near-vertical migration from the reservoir (114) due to a buoyancy-driven flow of hydrocarbons. A buoyancy-driven flow of hydrocarbons occurs when the upward buoyancy force of the hydrocarbons is greater than the downward force of gravity, causing an upward migration. Migration may be local, as shown in the petroleum system (100) of FIG. 1 or may occur over distances of hundreds of kilometers in larger sedimentary basins and is a crucial mechanism to the formation of a viable petroleum system (100).

The reservoir (114) contains an accumulation of hydrocarbons including oil and/or natural gas. The reservoir (114) is usually a permeable and porous rock layer capable of storing and transmitting hydrocarbon fluids. Reservoirs (114) are formed under temperature conditions that may preserve the hydrocarbons and are overlain by an impermeable layer or layers of rock, known as a hydrocarbon seal (112). The hydrocarbon seal (112) acts as a barrier to stop the further migration of hydrocarbons and may be accompanied with an appropriate topographic structure, such as an anticline which helps to further trap the accumulation of hydrocarbons within the reservoir (114). By understanding the regional relationships between the play risk elements of the petroleum system (100), which include information regarding the source rock formation (104), the reservoir (114), the seal formation (112) and the hydrocarbon charge, the veracity of PBE may be improved. The hydrocarbon charge describes a petroleum system's (100) likelihood of forming hydrocarbons, migrating, and being trapped in a reservoir (114) for economic extraction.

A hydrocarbon exploration may be conducted on a prospective petroleum system (100) by drilling into the suspected reservoir (114) in order to detect, quantify, or extract the hydrocarbons. A wellbore (102) may be drilled by a drill bit (126) attached by a drill pipe (106) to a drill rig (116) located on the Earth's surface (108). The wellbore (102) may traverse a plurality of overburden layers (110) and one or more seal formations (112) to a prospective hydrocarbon reservoir (114). The wellbore (102) may be drilled to perform any number of tests to analyze and broaden the knowledge and understanding of the hydrocarbon characteristics of the reservoir (114), including determining well logs from a logging system (120).

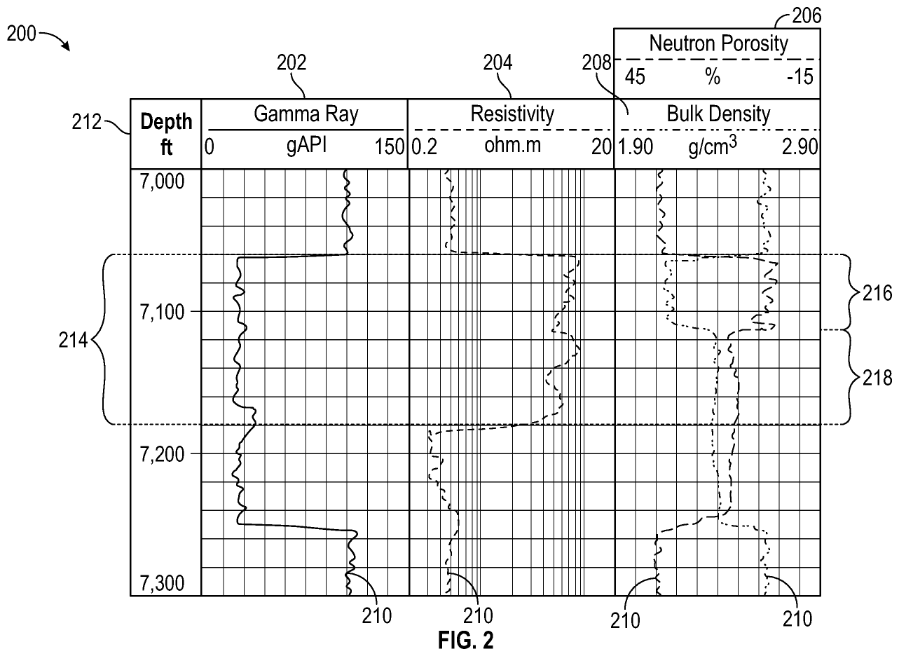

The logging system (120) may include the tools to determine a well log, including tools from a wireline logging or a logging while drilling (LWD) operation. A logging tool may be lowered into the wellbore (102) to acquire measurements as the tool traverses a depth interval. The plot of the logging measurements versus depth may be referred to as a “log” or “well log”. Well logs may provide depth measurements of the wellbore (102) that describe such reservoir characteristics as formation porosity, formation permeability, resistivity, water saturation, and the like. The resulting logging measurements may be stored or processed or both, for example, by a control system (122), to generate corresponding well logs for the wellbore (102). A well log and how it may be used to determine a depth interval containing a petroleum system element is explained in greater detail in FIG. 2.

Well test results (124), shown as a box in FIG. 1, may be taken from the wellbore (102) during the drilling or completion of the wellbore (102) and may include analyzing any available hydrocarbon show data. Hydrocarbon show data is any indication of oil and gas witnessed during well operations, including any hydrocarbons directly observed in drilling fluids, core samples, and cutting samples. Hydrocarbon show data may also include direct formation fluid samples taken at multiple intervals of the wellbore (102). Formation fluid samples or reservoir fluid samples may be retrieved and analyzed at the surface (108) during a well's production, or fluid recovery devices may be used during the drilling of the well to collect these fluid samples. These fluid samples may be analyzed, usually at a separate location such as a laboratory, to characterize the fluid composition to determine the type of fluid present. These fluid samples are analyzed to identify the presence of oil, gas, water, and combinations of multiple fluid types.

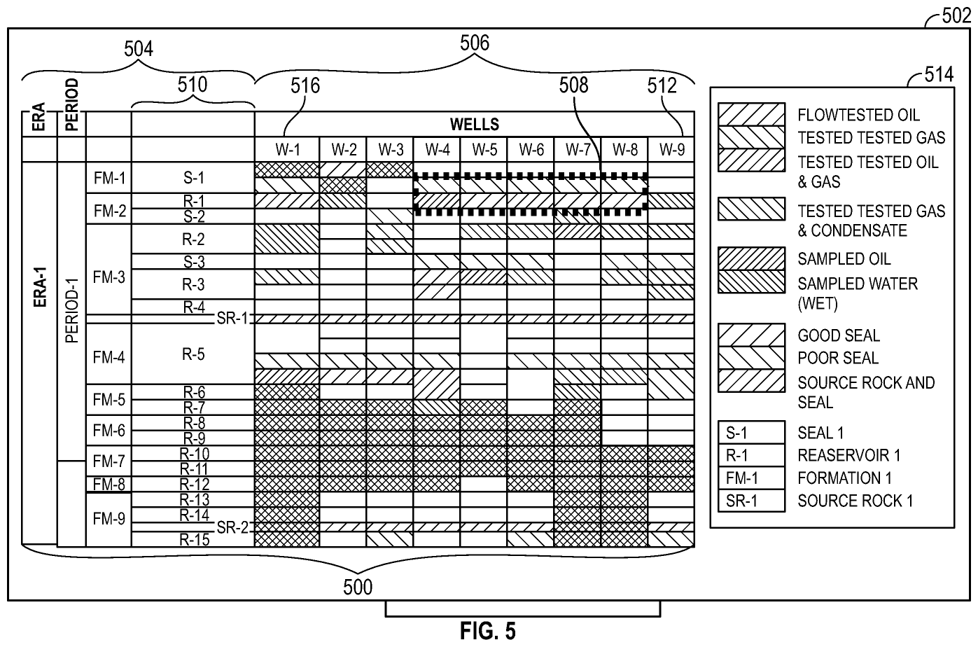

Well test results (124), may also include formation flow tests, which include taking several measurements while the formation fluids travel up the wellbore (102) to be collected. During the formation flow tests, the reservoir fluids are often channeled through a flowmeter (not shown) to determine a formation pressure, a hydrocarbon flow rate, and a fluid characterization. A hydrocarbon flow rate may be characterized as the volume of fluid that moves through a given cross-sectional area per unit time and is usually measured by a flowmeter. Determining a hydrocarbon flow rate may aid in determining certain reservoir formation characteristics such as the volume of hydrocarbons present in the reservoir (114) and the permeability of the formation. Permeability describes the ability for fluids to pass through the formation and is crucial in determining the quality of reservoir (114) present. These well tests results (124), which may include any sampled fluids or a hydrocarbon flow rate may be used in combination with well logs to determine a petroleum system description for a particular reservoir depth interval. These petroleum system descriptions may describe hydrocarbon test and show data in addition to seal and source rock quality determined based, at least in part, on the well logs and well test results (124). These petroleum system descriptions (124) are shown on a visual representation of FIG. 5, which helps to understand a regional petroleum system (100).

While a single wellbore (102) is illustrated in the petroleum system (100), hydrocarbon exploration and/or production typically involves a plurality of wellbores positioned at various locations of a reservoir (114). By collecting all the available data from the plurality of wellbores, including any well logs and well test results (124), a greater understanding of the petroleum system (100) may be developed. Decisions, including determining a new drilling target location, may be made based, at least in part, on this increased understanding of the petroleum system (100).

FIG. 2 depicts a series of well logs (200). The well logs (200) may be determined by a well logging system (120) described in FIG. 1. Some common logs, such as a gamma ray log (202), a resistivity log (204), a neutron porosity log (206), and a bulk density log (208) are shown, however, many more logs may be present during drilling operations as provided by logging tools. Additional logs may include directional density logs and sonic logs, such as compressional and shear sonic logs. Each log is a record of log values (210) at an associated well depth (212). Here, it is noted that the term well depth (212), or more simply the depth of the wellbore (102), refers to the distance along the wellbore (102) and does not necessarily correspond with the orthogonal distance from the surface (108) where the orthogonal distance is measured along an axis oriented perpendicular to the surface (108), also known as the true vertical depth. The term “distance” is used herein equivalently to well depth (212) and refers to the distance traversed through the wellbore (102). By way of example, a portion of a wellbore (102) may be oriented horizontally, or parallel to the surface (108), such that its orthogonal distance remains fixed over the horizontal portion, however, the well depth (212) measures the distance along the wellbore (102) and is not stagnant over any horizontal portion of the wellbore (102). Additionally, the well depth (212) is continuous and strictly monotonically increasing as directed from the surface (108) to the most down-hole portion of the wellbore (102) even if the orthogonal distance, or true vertical depth, decreases.

Using a LWD operation as an example, the various LWD tools sent down the wellbore (102) to produce recorded-mode LWD logs, which are automatically processed, calibrated, and combined together using a time-depth merge algorithm. The result of these processes is one or more measured parameters each displayed in a column against a single, shared, increasing depth axis on a composite depth (measured depth) log. In other words, the time-depth merge algorithm, when applied to recorded-mode LWD logs, produces conventional LWD well logs (200) as those shown in FIG. 2. These well logs (200) may be interpreted by recognizing the trends, which may describe such reservoir characteristics such as formation porosity, formation permeability, resistivity, water saturation, and the like. Interpreting the well logs (200) may include looking how the curves in the log values (210) deflect relative to each other. For example, the well log (200) in FIG. 2 may be used to identify a reservoir formation (214) at a particular well depth (212). Shown in FIG. 2, a gamma ray log (202) is used to predict varying lithology in the wellbore (102) by measuring the spontaneous emission of gamma ray radiation from rocks, a resistivity log (204) may be used to distinguish the nature of fluid in the geologic formation, a neutron porosity log (206) characterizes the porosity of the formation, and the bulk density log (208) measures the formation bulk density and further describes the porosity of the formation. By combining the nature of each one of these well logs (200), a reservoir formation (214) may be identified. The reservoir formation (214) may also be further defined using the neutron porosity log (206), and bulk density log (208) to categorize the reservoir formation fluid as being a gas (216) or oil (218). Many other important distinctions may be made using the well logs (200) including identifying lithology representative of the other petroleum system elements as well as identifying a water bearing formation (not shown). Well logs (200) may also be used to determine a stratigraphic column of the drilled formation. Well logs (200) may also be used, in combination with well test results (124) to categorize a petroleum system description, illustrated further in FIG. 5.

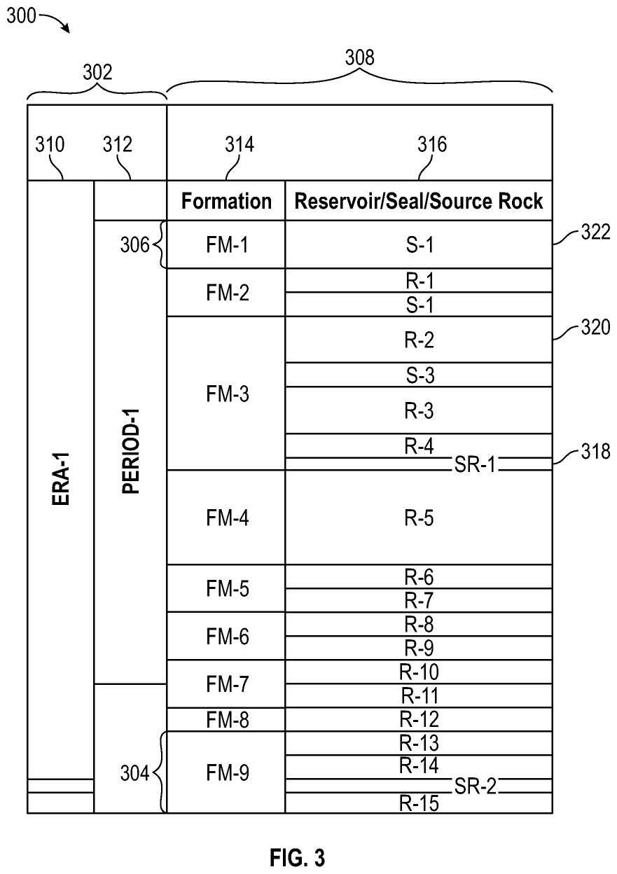

FIG. 3 depicts a stratigraphic column (300) in accordance with one or more embodiments. A stratigraphic column (300) is columnar diagram relating a vertical succession of identified rock units or petroleum system elements to the subdivisions of geologic time. Stratigraphic columns (300) are usually formed with the oldest rock formations (304) at the bottom of the diagram with increasingly younger rock formations as you move up the diagram, to the youngest rock formations (306) at the top of the diagram. The stratigraphic column (300) includes a geologic time column (302), which defines the relative geologic age of the rock formation. The geologic time column (302) may include one or more columns containing different divisions of geologic time. The geologic time column (302) includes an era sub column (310), the second largest geochronological time unit, and a period sub column (312) which is the third largest geochronological time unit that further defines a rock units geological age more precisely. While not shown, the geologic time column (302) may also include an eon sub column, an epoch sub column or an age sub column. The geologic time column (302) is meant only to broadly categorize the age of a particular formation and form a visual relationship to the identified rock units.

The stratigraphic column (300) may also include one or more columns (308) concerned with identifying the specific rock formations (314) and petroleum system formations (316). A rock formation (314) includes a collection of rock that is distinctive from surrounding rock layers. Using all the available regional geologic information and the principles of stratigraphy, a rock formation (314) may be defined for a particular depth interval. The rock formation (314) may be further classified into a petroleum system formation (316), which classifies a particular rock formation (314) into a source rock (318), a reservoir (320) and a seal (320). The source (318), reservoir (320) and seal (322) have been described in FIG. 1 and represent the three necessary components of a petroleum system (100). The relationships between these three components and their relative stratigraphic positions help to visualize the play risk elements of the petroleum system (100).

The stratigraphic column (300) may be determined based, at least in part, on a well log (200) in accordance with one or more embodiments. FIG. 2 has described how interpreting a well log (200) may be used to identify a reservoir formation (214). By using well logs and any other available information regarding the regional geology of an area of interest, including well test results (124) and geologic models, a petroleum system formation (316) may be defined on the stratigraphic column (300). Turning back to FIG. 1, hydrocarbon exploration typically involves a plurality of wellbores positioned at various locations of a reservoir (114). Well logs (200) may be obtained from each one of these wellbores and a stratigraphic column (300) may be created, based at least in part, on each one of the well logs (200). The stratigraphic columns (300) from each of these wellbores may be used to determine a regional stratigraphic column in accordance with one or more embodiments. The regional stratigraphic column may be determined by determining an average depth interval that categorizes the petroleum system formation (316) using the information from each gathered well log (200).

For example, using a known formation labeled FM-1, and three stratigraphic columns in the area of interest, the regional stratigraphic column will be determined based on the average depth interval categorizing the petroleum system formation (316) using all three stratigraphic columns. The three stratigraphic columns used in this example, hypothetically have characterized the FM-1 formation as being a seal formation (322) or S-1. The three stratigraphic columns have defined the petroleum system formation (316) S-1 beginning at depths of 7,000 feet (ft), 6,950 ft and 7,050 ft and ending at depths of 7,600 ft, 7,550 ft and 7,650 ft. The regional stratigraphic column would then display the S-1 petroleum system formation (316)S-1 from 7,000 ft to 7,600 ft, or an average depth interval of all three stratigraphic columns. The regional stratigraphic column represents the best summarized vertical succession of the petroleum system elements of a particular region and may be used to quickly categorize regional petroleum system trends and relationships to evaluate the play risk elements. A stratigraphic column (300) or regional stratigraphic column may include other elements not visualized in FIG. 3 including columns that indicates bed thickness, rock illustrations, weathering profiles, grain size, rock descriptions, among other rock and reservoir properties.

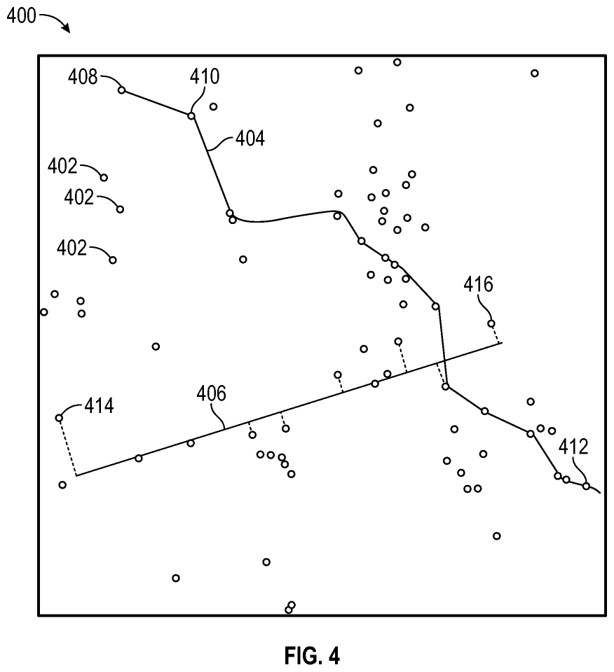

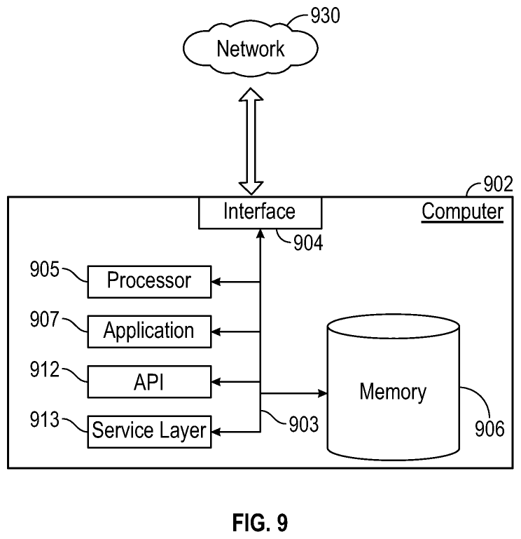

FIG. 4 depicts a spatial map (400) in accordance with one or more embodiments. The spatial map (400) may be used to define an area of high PBE interest using a line of section (404, 406). The spatial map (400) may be visualized on a display device connected to a computer system. The computer system is configured to perform all functions associated with the description of FIG. 4 and may be similar to the computer system (902) described below with regard to FIG. 9 and the accompanying description. The spatial map (400) will be used to define a line of section (404, 406) which is used to select a plurality of wellbores for a visual representation. The visual representation will incorporate the regional stratigraphic column aligned with a petroleum system description from each one of the wellbores incorporated onto the line of section (404, 406) to enable a quick and efficient regional analysis for a PBE and is discussed further in FIG. 5.

The spatial map (400) includes a plurality of wellbores that penetrate a subsurface region of interest, each having wellheads (402) shown as black dots on the spatial map (400). A wellhead (402) is a surface component of a wellbore that provides pressure control of a production well. Wellheads (402) are usually cataloged with spatial coordinates making them easy to plot and identify on a spatial map (400). The plurality of wellbores that penetrate the subsurface region of interest may be interrogated to define an area of high PBE interest, and the line of section (404,406) may be formed on the spatial map (400) that traverses though this area. Spatial coordinates of these wellheads (402) may then be projected onto this line of section (404, 406).

Shown in FIG. 4, the line of section (404, 406) may be formed using two methods. The first line of section (404) may be formed by traversing directly through multiple wellhead (402) locations on the spatial map (400). The first line of section (404) is shown in FIG. 4 with a starting wellhead location (408) and the line moves directly to an adjacent wellhead location (410) until reaching an ending wellhead location (412). The wellheads (402) may be chosen based on the determined PBE area of interest and the available data of the wellbore, including having well logs (200) and well test results (124). The second line of section (406) may be formed unconstrained by wellhead (402) locations. In this case, any line may (straight, curved, etc.) be formed on the spatial map (400) and the wellheads (402) may be projected onto this line. The second line of section (406) is shown in FIG. 4 with a starting wellhead location (414) being projected onto the line (406) and the line is formed in a straight direction through an area high PBE interest until reaching an ending wellhead location (416) that may be projected onto the line (406).

The line of sections (404, 406) may both traverse through the wellhead (402) locations, while having other wellheads (402) being projected on the line (404, 406). While not a requirement of the line of sections (404, 406), it may be advantageous for the wellheads (402) being traversed through or projected onto the lines (404, 406) to have a relatively consistent spacing between adjacent wellhead (402) locations. Maintaining a relative consistent spacing may be advantageous to understanding the gradual regional changes and trends in the petroleum system, when incorporated into the visual display of FIG. 5. Furthermore, while any line of section (404, 406) may be formed on the spatial map (400), a line that incorporates wellbores that have both a well log (200) and well test result (124) may be preferred.

In some embodiments, the spatial map (400) may include a reservoir indicating attribute overlaid on the spatial map (400), which may help to determine a strategically formed line of section (404, 406). These reservoir indicating attributes may include attributes from a seismic dataset of the region. Seismic attributes including amplitude, acoustic impedance, spectral decomposition, or any seismic attribute that may give an indication of reservoir characteristics may be used. Other reservoir indicating attributes apart from the forementioned seismic attributes may also be incorporated as overlays on the spatial map (400) to help determine an advantageous location of the line of section (404, 406). Furthermore, while the wellbores (402) are shown as black dots in FIG. 4, these dots may be color-coded, or contain varying symbols that indicate the availability of wellbore information. By using color-codes or symbols, the wellbores (402) may be easily identified as having well logs (200) and/or well test results (124) available, which are to be included in the visual representation.

FIG. 5 depicts a visual representation (500) aiding in PBE in accordance with one or more embodiments. The visual representation (500) may be generated, with a regional stratigraphic column (504) aligned with a petroleum system description (506) from each of the plurality of wellbores that have been projected onto the line of section (404, 406). The visual representation (500) provides a regional stratigraphic column (504) to correlate the data encountered by the plurality of wellbores that penetrate the subsurface region of interest. The visual representation (500) allows for a quick local and regional analysis of play risk elements, including reservoir, source, charge, and seal, thereby improving the veracity of a PBE. The visual representation (500) may be displayed on a display device (502) to define the relationship of the play elements and interrogated to identify a drilling target pattern (508), which may aid in determining a drilling target for a new production or exploration well.

The visual representation (500) may be generated by partitioning the regional stratigraphic column (504) aligned with each petroleum system description (506) into a series of rows that categorize a petroleum system formation (510). The series of rows are extended to incorporate the petroleum system descriptions (506) from each one of the wellbores projected onto the line of section (404, 406). The petroleum system descriptions (506), identify documented occurrences of sampled fluids or known hydrocarbon flow rates within a given depth interval to help specify locations of recorded cases of known formation fluids. The petroleum system descriptions (506) also identify a seal and source quality and provides regional relationships between petroleum system elements.

The plurality of wellbores that have been projected onto the line of section (404, 406) are positioned on the visual representation (500) in order from a starting wellhead location (516) to an ending wellhead location (512). The starting wellhead location (516) is located directly adjacent to the regional stratigraphic column (504) and the ending wellhead location (512) is positioned furthest away from the stratigraphic column (504). The series of rows are then labeled on the visual display, based on the petroleum system descriptions (506) for each of the plurality of wellbores, using a plurality of differentiators (514). The plurality of differentiators (514) appears on the visual representation (500) as unique patterns and symbols that describe petroleum system descriptions (506), however other types of visual differentiators (514) may be used, such as a unique color scheme in accordance with one or more embodiments. The purpose of the differentiators (514) is to aid in a quick and efficient visual inspection of a well's interval properties. These differentiators (514) when observed plotted along a line of section and anchored to a regional stratigraphic column (504) enable efficient visual analysis of both local and regional play risk elements to determine a drilling pattern (508), shown as a dashed box in FIG. 5. While in some embodiments, the differentiators (514) used in FIG. 5 appear as specific patterns that describe the petroleum system descriptions (506), a lack of a pattern may also be used to visualize information. For example, in the visual representation (500) the petroleum system formation (510) “R-4” lacks a differentiator pattern across all wells. In some embodiments, this blank space may represent a reservoir formation with no seal to contain the hydrocarbons. In other embodiments, a blank space may communicate other pertinent information regarding the play risk elements.

Turning back to FIG. 1, the regional relationships between the play risk elements were discussed, to characterize a potential hydrocarbon charge. By recognizing these regional relationships, using the visual representation (500) the necessary elements of determining a new production or exploration well may be determined. For example, by observing the drilling pattern (508) enclosed by the dashed rectangles in FIG. 5, it may be observed that wells W-4, W-5, W-6, W-7, and W-8 all have known instances of tested or sampled hydrocarbon fluids within the petroleum system formation (510) “R-1”. These wells also have a known source petroleum system formation (510) “SR-1” that exists under the “R-1” formation, and Well W-7 has a poorly rated seal between the source and the reservoir, which may allow of a continued migration of hydrocarbons into the reservoir. Finally, the wells inside the identified drilling pattern (508) include a good seal that overlays the reservoir, which may trap the migrating hydrocarbons in the reservoir formation. One skilled in the arts may examine the visual representation (500) and quickly identify a drilling pattern (508) and may choose a drilling target based, at least in part, on this identified drilling pattern. An exploration or production well in the near vicinity of well W-7, at the depth of petroleum system formation (510) “R-1”, may be chosen as the drilling target as it includes all the necessary elements for having a good petroleum charge.

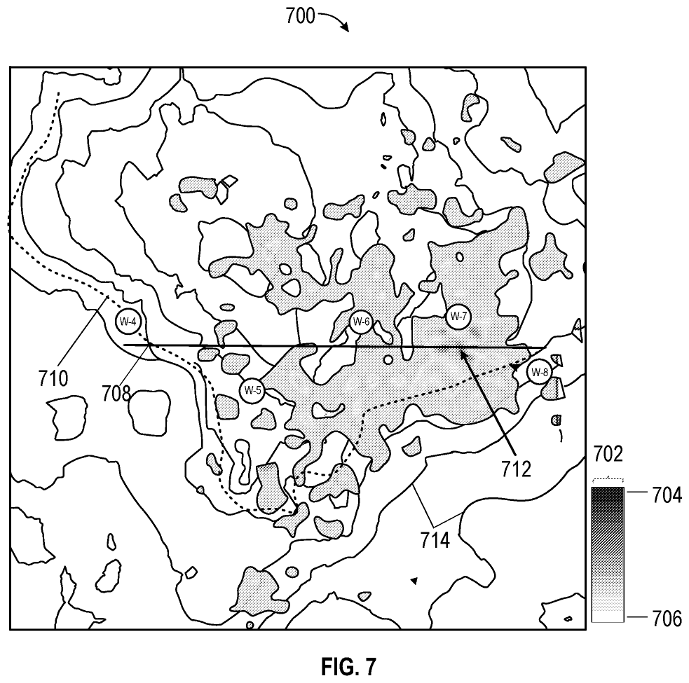

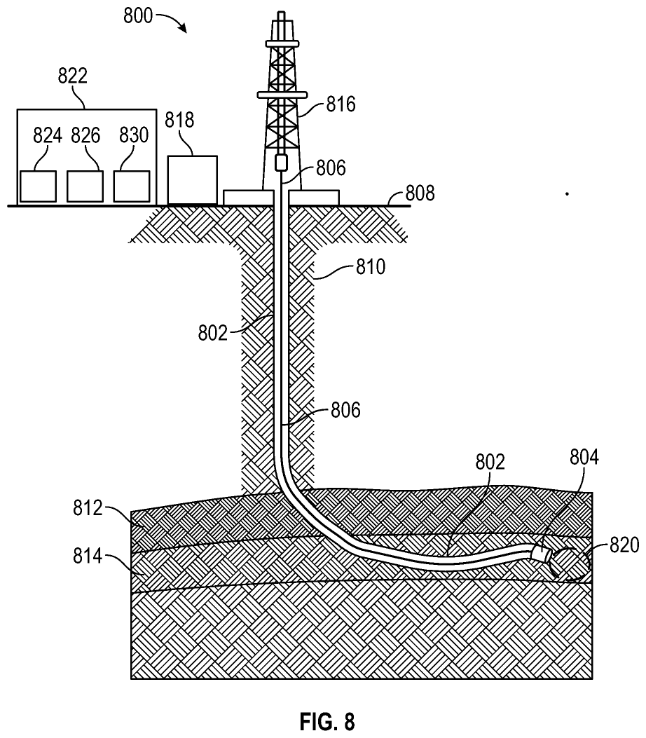

The display device (502) may be connected to a computer system (not shown). The display device (502) may be the same display device (502) used to form the line of section, or it may be a separate display device (502) in accordance with one or more embodiments. The computer system may be the same computer system used to perform the functions described in FIG. 4, or a separate computer system, including an interpretation workstation. An interpretation workstation may incorporate the visual representation (500) along with any number of geologic models to determine the drilling target in accordance with one or more embodiments. The interpretation workstation may also be used to determine the drilling target, based on the visual representation (500) alone, in accordance with one or more embodiments. A wellbore path may be planned, using a wellbore path planning system, to intersect the drilling target, and a drilling system may be used to drill the wellbore guided by this wellbore path. The interpretation workstation, the wellbore path planning system, and the drilling system are illustrated and discussed further in FIG. 8. In some embodiments, the drilling pattern (508) may be used as a screening criterion for interrogating the area further using an attribute map to determine a drilling target with higher confidence. The attribute map may include seismic attributes indicative of a reservoir formation and is discussed further in the context of FIG. 7.

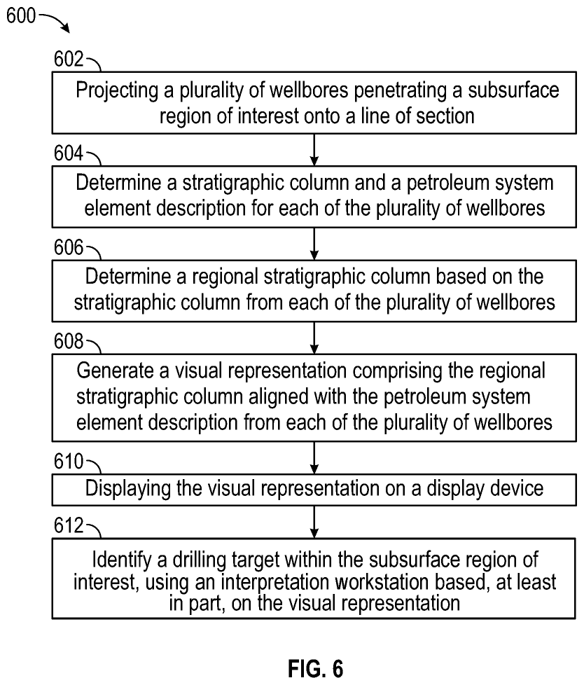

FIG. 6 shows a flowchart (600) in accordance with one or more embodiments. In Step 602, a plurality of wellbores penetrating a subsurface region of interest may be projected onto a line of section. Projecting the plurality of wellbores may include interrogating a spatial map of wellbores that penetrate the subsurface region of interest, forming the line of section on the spatial map, and then projecting spatial coordinates of a wellhead from at least one of the plurality of wellbores onto the line of section. The spatial map may be used to define an area of high PBE interest using the line of section to traverse this area for further inspection. The spatial map may also include a reservoir indicating attribute, overlaid on the spatial map. These reservoir indicating attributes may include attributes from a seismic dataset in the region, including amplitude, acoustic impedance, spectral decomposition, or any seismic attribute that may give an indication of reservoir characteristics may be used. Any other attributes may be overlaid on the spatial map other than from a seismic dataset, to help determine an advantageous location of the line of section.

In Step 604, a stratigraphic column and a petroleum system element description may be determined for each of the plurality of wellbores. Determining the stratigraphic column and the petroleum system description may include obtaining a well log and a well test result, determining the stratigraphic column based, at least in part, on the well log, and determining the petroleum system description based, at least in part, on the well log and the well test result. The well test result may include a hydrocarbon flow rate. The stratigraphic column may include one or more columns concerned with identifying the specific rock formations and petroleum system formations. A petroleum system formation may be labeled on the stratigraphic column that classifies a particular rock formation as a source, reservoir, or seal formation. Well test results may also include any available hydrocarbon show data directly observed in drilling fluids, core samples, and cutting samples. Well test results may also include direct formation fluid samples extracted from the wellbore. The well test results may be analyzed to identify the presence of oil, gas, water, to help determine a petroleum system description. The petroleum system descriptions include documented cases of sampled or tested fluids and may also include seal and source rock quality descriptions.

In Step 606, a regional stratigraphic column may be determined based on the stratigraphic column from each of the plurality of wellbores. The regional stratigraphic column may include determining an average depth-interval categorizing a petroleum system formation. The petroleum system formation may include a broad formation description including a seal formation, a source formation, or a reservoir formation. The regional stratigraphic column represents the best summarized vertical succession of petroleum system elements of a particular region and may be used to quickly categorize regional petroleum system trends and relationships to evaluate the play risk elements.

In Step 608, a visual representation may be generated that includes the regional stratigraphic column aligned with the petroleum system description from each of the plurality of wellbores. The visual representation provides a regional stratigraphic column to correlate the data encountered by the plurality of wellbores that penetrate the subsurface region of interest. The visual representation allows for a quick local and regional analysis of play risk elements, including reservoir, source, charge, and seal, thereby improving the veracity of a PBE. The visual representation may be generated by partitioning the regional stratigraphic column aligned with each petroleum system description into a series of rows that categorizes a petroleum system formation and labeling each petroleum system description using a plurality of differentiators. The series of rows may be positioned in order from a starting wellhead location on the line of section to an ending wellhead location on the line of section. The visual representation may also include a legend that labels the differentiators. The differentiators may include a unique color, a unique pattern, or anything that may be used to visually identify a pattern in the visual representation.

In Step 610, the visual representation may be displayed on a display device. The display device may be connected to the computer system used to generate the display, or the display device may be at a separate location from the computer system used to generate the display. In Step 612, a drilling target within the subsurface region of interest may be identified using an interpretation workstation based, at least in part, on the visual representation. The drilling target may be identified by interrogating the visual representation to identify a drilling target pattern based on a plurality of differentiators. The visual representation allows for quick and efficient regional visual analysis by defining the relationship of the play elements across the line of section. The vertical succession of petroleum system elements found on the visual representation allows for regional relationships to be formed quickly, thereby identifying an advantageous drilling target based, at least in part, on the visual representation. The drilling target may be identified using the drilling target pattern identified from the visual representation alone, or in combination with other information gathered on the reservoir, including from geologic models from the region. A wellbore path may be planned using a wellbore path planning system, to intersect the drilling target and a wellbore may be drilled, guided by the wellbore path, using a drilling system. While in some embodiments, the drilling target may be identified by interrogating the visual representation, in other embodiments the visual representation may be used as a screening criterion to select a potential drilling target to be interrogated further using an attribute map.

FIG. 7 depicts an attribute map (700) in accordance with one or more embodiments. The attribute map (700) may be similar to the spatial map (400) of FIG. 4, with an additional reservoir indicating attribute overlaid for analysis. Turning to FIG. 4, utilizing an attribute map (700) was described as one possible method to increase confidence in selecting the line of section (404, 406) for the visual representation (500). In some embodiments, an attribute map (700) may be used for selecting or verifying a drilling target after a drilling pattern (508) has been determined from the visual representation (500). In these embodiments, after identifying a drilling pattern (508) from the visual representation (500), an attribute map (700) is interrogated specifically through the line of section (708) that has been determined a candidate for a drilling target. The reservoir indicating attributes located on the attribute map (700) may confirm a drilling target or may further narrow a drilling targets precise location prior to planning the wellbore path to intersect this drilling target.

The reservoir indicating attribute may be an attribute originating from a seismic dataset in accordance with one or more embodiments. Seismic attributes are any quantity or property that has been extracted from seismic data including amplitude, acoustic impedance and spectral decomposition among others. Other reservoir indicating attributes apart from the forementioned seismic attributes may also be incorporated as overlays. Specifically in FIG. 7, seismic amplitude is shown as the reservoir indicating attribute having values defined by the grayscale bar (702). The grayscale bar (702) defines high amplitudes in a black color (704) and low amplitudes in a white color (706). The seismic amplitudes are overlaid on the spatial map to create an attribute map (700) and may be analyzed to form a narrower drilling target.

As shown in FIG. 7, the wells (W-4, W-5, W-6, W-7, W-8) along the line of section (708) are plotted on the attribute map (700). These wells have been identified using the visual representation (500) as a drilling target candidate, at the depth of petroleum system formation (510) “R-1”. Contour lines (714) may be included on the attribute map (700) to visualize a depth of formation and provide for a subsurface structure. Contour lines (714) are lines formed on a map that indicate an equal elevation. Each contour line (714) drawn represents an increase or decrease of a constant elevation interval and may be helpful for determining subsurface formations. In some embodiments, the contour lines (714) may represent the depth of the reservoir indicating attributes extracted from a dataset, and in this case represents the depth of seismic amplitudes overlaid on the attribute map (700). Shown in FIG. 7, the top or the shallower boundary of the “R-1” formation is shown as a dashed line and represents a hydrocarbon down-to-depth (HCDT) contour (710). This HCDT contour (710) represents the top portion, or the shallowest boundary of the drilling target determined from the visual representation (500). The HCDT contour (710), the location of the wells along the line of section (708), and the overlaid seismic amplitude may be analyzed all at once using the attribute map (700) to determine a narrower drilling location.

By interrogating the attribute map (700) a bright spot (712) may be seen in the vicinity of the wells along the line of section (708) and the HCDT contour (710). A bright spot (712) describes a local area within the subsurface with high seismic amplitudes and may be a good indicator for a reservoir. By using the all the elements included on the attribute map (700), including the subsurface structures the contour lines (714) provide and the seismic attributes indicating a reservoir, a more detailed analysis of the play elements may be performed and a narrower drilling target may be determined. Furthermore, overlaying seismic attributes over a potential drilling target may aid in identifying drilling hazards within the subsurface including faults, shallow gas pockets, or over-pressure zones. By identifying any drilling hazards near the drilling target, the wellbore path may be planned using a wellbore path planning system to avoid these hazards.

FIG. 8 depicts a drilling system (800) in accordance with one or more embodiments. As shown in FIG. 8 a wellbore path (802) may be drilled by a drill bit (804) attached by a drillstring (806) to a drill rig (816) located on the surface of the Earth (808). The well may traverse a plurality of overburden layers (810) and one or more cap-rock layers (812) to a drilling target (820) within a hydrocarbon reservoir (814). The wellbore path (802) may be a curved well path, or a straight well path. All or part of the wellbore path (802) may be vertical, and some well paths may deviate or have horizontal sections.

Prior to the commencement of drilling, the drilling target (820) may be determined using an interpretation workstation (822), based on a visual representation (824), generated using the method (600) described herein. Further, a drilling target (820) may also be determined from an interpretation workstation (822) using the visual representation (824) in combination with other information gathered on the hydrocarbon reservoir (814), including from geologic models (826) and reservoir models (830). A geologic model (828) is a spatial representation of the distribution of sediments and rocks (rock types) in the subsurface. The reservoir models (830) may include information regarding total hydrocarbon in place, where the hydrocarbons are located, and how effectively the hydrocarbons can potentially flow.

The interpretation workstation (822) may include hardware and/or software with functionality for performing one or more reservoir interpretations regarding determining the drilling target (820) in the reservoir (814). The drilling system (800) may also include a wellbore path planning system (818). A wellbore path (802) may be planned, using a wellbore path planning system, to intersect the drilling target (820). The wellbore plan may include a starting surface location of the wellbore, or a subsurface location within an existing wellbore, from which the wellbore may be drilled. Further, the wellbore plan may include a drilling target (820) and a planned wellbore path from the starting location to the drilling target (820). Typically, the wellbore plan is generated based on best available information from a geophysical model associated with the geo-physical properties of the subsurface (e.g., wave speed or velocity, density, attenuation, anisotropy), geomechanical models encapsulating stress conditions in a subsurface region of interest, the trajectory of any existing wellbores (which it may be desirable to avoid), and the existence of other drilling hazards, such as shallow gas pockets, over-pressure zones, and active fault planes. Furthermore, the wellbore plan may take into account other engineering constraints such as the maximum wellbore curvature (“dog-log”) that the drillstring may tolerate and the maximum torque and drag values that the drilling system may tolerate.

The wellbore path planning system (818) may comprise one or more computer processors in communication with computer memory containing the geophysical and geomechanical models, reservoir simulations, information relating to drilling hazards, and the constraints imposed by the limitations of the drillstring (806) and the drilling system (800). The wellbore path planning system (818) may further include dedicated software to determine the planned wellbore path and associated drilling parameters, such as the planned wellbore diameter, the location of planned changes of the wellbore diameter, the planned depths at which casing will be inserted to support the wellbore and to prevent formation fluids entering the wellbore, and the drilling mud weights (densities) and types that may be used during drilling the wellbore. A wellbore may be drilled, guided by the wellbore path, using the drilling system (800).

While the interpretation workstation (822) and wellbore path planning system (818) are shown at the drilling system (800) location, in some embodiments, these elements may be remote from the drilling system (800) location. In some embodiments, the interpretation workstation (822) and wellbore path planning system (818) may include one or more computer systems that are similar to the computer system (902) described below with regard to FIG. 9 and the accompanying description.

FIG. 9 depicts a block diagram of a computer system used to provide computational functionalities associated with described algorithms, methods, functions, processes, flows, and procedures as described in this disclosure, according to one or more embodiments. The illustrated computer (902) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include a computer that includes an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component (or a combination of roles) of a computer system for performing the subject matter described in the instant disclosure. The illustrated computer (902) is communicably coupled with a network (930). In some implementations, one or more components of the computer (902) may be configured to operate within environments, including cloud-computing-based, local, global, or other environment (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) from a client application (for example, executing on another computer (902) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities through a defined interface. For example, the interface may be software written in JAVA, C++, or other suitable language providing data in extensible markup language (XML) format or another suitable format. While illustrated as an integrated component of the computer (902), alternative implementations may illustrate the API (912) or the service layer (913) as stand-alone components in relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers (902) associated with, or external to, a computer system containing computer (902), wherein each computer (902) communicates over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers (902).

In some embodiments, the interpretation workstation (822) used in the method (600) disclosed herein, may perform their functions using a first computer (902) and one or more first Applications (907) while the wellbore path planning system (818) may generate a wellbore path (802) on a second computer (902) using one or more second Applications (907).

Although only a few example embodiments have been described in detail above, those skilled in the art will readily appreciate that many modifications are possible, including dimensions, in the example embodiments without materially departing from this invention. Accordingly, all such modifications are intended to be included within the scope of this disclosure as defined in the following claims.

What is claimed:

1. A computer-implemented method, comprising:
projecting a plurality of wellbores penetrating a subsurface region of interest onto a line of section;
for each of the plurality of wellbores, determining a stratigraphic column and a petroleum system description;
determining a regional stratigraphic column based on the stratigraphic column from each of the plurality of wellbores;
generating a visual representation comprising the regional stratigraphic column aligned with the petroleum system description from each of the plurality of wellbores;
displaying the visual representation on a display device; and
identifying, using an interpretation workstation, a drilling target within the subsurface region of interest based, at least in part, on the visual representation.

2. The method of claim 1, further comprising planning a wellbore path, using a wellbore path planning system, to intersect the drilling target.

3. The method of claim 2, further comprising drilling a wellbore, guided by the wellbore path, using a drilling system.

4. The method of claim 1, wherein projecting the plurality of wellbores comprises:
interrogating a spatial map of wellbores penetrating the subsurface region of interest;
forming the line of section on the spatial map; and
projecting spatial coordinates of a wellhead from at least one of the plurality of wellbores onto the line of section.

5. The method of claim 4, wherein the spatial map further comprises a reservoir indicating attribute overlaid on the spatial map.

6. The method of claim 1, wherein determining the stratigraphic column and the petroleum system description comprises:
obtaining a well log and a well test result;
determining the stratigraphic column based, at least in part, on the well log; and
determining the petroleum system description based, at least in part, on the well log and the well test result.

7. The method of claim 6, wherein the well test result comprises a hydrocarbon flow rate.

8. The method of claim 1, wherein determining the regional stratigraphic column comprises determining an average depth interval categorizing a petroleum system formation.

9. The method of claim 1, wherein generating the visual representation comprises:
partitioning the regional stratigraphic column aligned with each petroleum system description into a series of rows that categorizes a petroleum system formation; and
for each of the plurality of wellbores:
labeling each petroleum system description using a plurality of differentiators.

10. The method of claim 9, wherein the series of rows that categorizes the petroleum system formation are positioned in order from a starting wellhead location on the line of section to an ending wellhead location on the line of section.

11. The method of claim 1, wherein identifying the drilling target further comprises interrogating the visual representation to identify a drilling target pattern based on a plurality of differentiators.

12. A system configured to generate a visual representation from a spatial map containing a plurality of wellbores, comprising:
a computer processor configured to:
project the plurality of wellbores that penetrate a subsurface region of interest onto a line of section, wherein each of the plurality of wellbores include
a well log and a well test result,
determine a stratigraphic column for each of the plurality of wellbores based, at least in part, on the well log,
determine a petroleum system description for each of the plurality of wellbores based, at least in part, on the well log and the well test result,
determine a regional stratigraphic column based on the stratigraphic column from each of the plurality of wellbores,
generate the visual representation comprising the regional stratigraphic column aligned with the petroleum system description from each of the plurality of wellbores, and
display the visual representation on a display device; and
an interpretation workstation configured to identify a drilling target within the subsurface region of interest based, at least in part, on the visual representation.

13. The system of claim 12, further comprising:
a wellbore path planning system configured to plan a wellbore path to intersect the drilling target; and
a drilling system configured to drill a wellbore, guided by the wellbore path.

14. The system of claim 12, wherein projecting the plurality of wellbores comprises:
interrogating the spatial map of wellbores penetrating the subsurface region of interest;
forming the line of section on the spatial map; and
projecting spatial coordinates of a wellhead from at least one of the plurality wellbores onto the line of section.

15. The system of claim 14, wherein the spatial map further comprises a reservoir indicating attribute overlaid on the spatial map.

16. The system of claim 12, wherein the well test result comprises a hydrocarbon flow rate.

17. The system of claim 12, wherein determining the regional stratigraphic column comprises determining an average depth interval categorizing a petroleum system formation.

18. The system of claim 12, wherein generating the visual representation comprises:
partitioning the regional stratigraphic column aligned with each petroleum system description into a series of rows that categorizes a petroleum system formation; and
for each of the plurality of wellbores:
labeling each petroleum system description using a plurality of differentiators.

19. The system of claim 18, wherein the series of rows that categorizes the petroleum system formation are positioned in order from a starting wellhead location on the line of section to an ending wellhead location on the line of section.

20. The system of claim 12, wherein identifying the drilling target further comprises interrogating the visual representation to identify a drilling target pattern based on a plurality of differentiators.
